(19) United States
(12) Patent Application Publication
(10) Pub. No.: US 2005/0240878 A1
(43) Pub. Date: Oct. 27, 2005

(54) System and method for scaling icons

(75) Inventors: Colin R. Anthony, Kirkland, WA (US); Tyler K. Beam, Redmond, WA (US); Raymond J. Chen, Redmond, WA (US); Charles Cummins, Seattle, WA (US); Robert F. Day, Bellevue, WA (US); Paul A. Gusmorino, Seattle, WA (US); Jenny T. Lam, Seattle, WA (US); Isaac A. Sheldon, Seattle, WA (US); David G. De Vorchik, Seattle, WA (US)

Correspondence Address: SHOOK, HARDY & BACON L.L.P., 2555 GRAND BOULEVARD, KANSAS CITY, MO, 64108-2613, US

(73) Assignee: Microsoft Corporation, Redmond, WA (US)

(21) Appl. No.: 10/831,145

(22) Filed: Apr. 26, 2004

(51) Int. Cl. G06F 9/00; G06F 17/00

(52) U.S. Cl. 715/765; 715/835; 715/838

(57) ABSTRACT

A method and system are provided for displaying icons in accordance with user preferences. The method includes providing a user with a size selection mechanism for selecting an icon size from a range of sizes. The method additionally includes searching a set of stored resources related to the underlying file and generating the icon in the selected size based upon the stored resources. The method may additionally include selecting an icon type including one of a traditional icon and thumbnail icon based on at least one of the user's size selection and the represented file. Furthermore, the icon display system of the invention positions labels and overlays in the vicinity of the icon based upon the selected size of the icon.

### CROSS-REFERENCE TO RELATED APPLICATIONS

None.

### STATEMENT REGARDING FEDERALLY SPONSORED RESEARCH OR DEVELOPMENT

None.

### TECHNICAL FIELD

Embodiments of the present invention relate to improving a computer user experience through the user interface and more particularly to scaling of icons in accordance with user preference.

### BACKGROUND OF THE INVENTION

Icons have been used for many years in computer systems to display information to users. Icons are images that are used to represent items such as files, folders, shortcuts, applications, documents, tasks, and commands throughout a computer operating system such as Microsoft Windows, a product of the Microsoft Corporation of Redmond, Wash. Icons are currently used in toolbars, dialog boxes, menus, and numerous other locations in file management systems such as Windows Explorer, also a product of the Microsoft Corporation. Icons are usually stored as static bitmaps, but dynamic icon handlers may also be written to generate icons dynamically.

Currently, two types of icons are used to represent items. These two types include traditional icons and thumbnail icons. Whereas traditional icons are typically shared across files and are determined per type, thumbnails are determined per item and are not shared across files. A traditional icon is composed of two components including an icon image and a status overlay. The icon image forms the basis of the traditional icon. The status overlay is used to convey status information about the item. It is used, for example, to display the shortcut overlay.

A thumbnail icon is a particular type of icon displaying an image generated based on the contents of the underlying item. For example, an icon for an image file that actually looks like the image itself is a thumbnail of the image file. Thumbnail icons may also include an overlay. Thumbnail icons may be dynamically generated by code run on a user computer, although the generated image may be cached.

Although existing operating systems offer thumbnails, these thumbnails are not well integrated into existing file management systems such as Windows Explorer. As a result, the thumbnail feature is not as useful as it could be. A user has to go to a special “thumbnails view” to see thumbnail icons today, even for objects having thumbnail icons that would be visually effective at a smaller size, such as photographs. When in the thumbnails view of existing systems, icons for objects without thumbnails appear small and inadequate. The user typically cannot see extra information about each file in thumbnails view as the user can in other views such as tile view or details view. Accordingly, the user is often forced to choose between viewing thumbnails and viewing other important information.

Because the thumbnails feature is remote and not extensively utilized, little incentive exists for Independent Software Vendors (ISVs) to write thumbnail generators, When ISVs do write the thumbnail generators, they are unlikely to invest in making the thumbnail generators powerful. As a result, many existing application produce thumbnails of poor quality. Generally, since thumbnails are pictures, it is difficult to determine what type of item underlies a thumbnail icon. Furthermore, while traditional icons appear instantly, thumbnail icons are typically noticeably slow to appear because they were not generated in advance.

With traditional icons, overlays are often used as a primary or only indication of information about an item underlying an icon. However, overlays do not reliably appear. If multiple states need to be shown, overlays will only show the highest priority state and will ignore others since no more than one overlay may be shown at a time. Overlays are difficult to recognize at small icon sizes, such as the sizes generally used in list or details mode. Overlays have additional drawbacks including the ability to be readily imitated and used in an unauthorized manner. A further limitation is the inaccessibility of overlays to the visually-impaired. A user navigating with the keyboard and using a narrator hears a name and type of each file as the file is selected, but is not given any information about a state that the overlay represents. Additionally, overlays are used inconsistently to convey information about the state of a file.

As set forth above, current icon display systems often result in icons that are too small or unable to display adequate information to the user. Accordingly, a solution is needed that effectively manipulates icons to enhance the user experience. An effective solution preferably implements traditional icons, thumbnail icons, and overlays in a manner effective for displaying valuable information quickly and efficiently. Further a solution is needed that allows users to resize their icons in real time will when performing routine tasks like accessing files through a file management system. The ability of a user to control icon displays will enhance the user experience. Further, a solution is needed for improving thumbnail image presentation to help home users manage their digital media and knowledge workers manage their documents. Development and integration of icons will enhance the user experience.

### BRIEF SUMMARY OF THE INVENTION

Embodiments of the present invention are directed to a method for displaying an icon representing an underlying file on a user interface. The method includes providing a user with a size selection mechanism for selecting an icon size from a range of sizes. The method further includes searching a set of stored resources related to the underlying file and generating the icon in a user selected size based upon the stored resources.

In another aspect of the invention, a method is provided for enhancing display of icons on a user interface. The method includes providing a user selection component for allowing a user to select an icon size for an icon representing a file. The method additionally includes selecting an icon type including one of a traditional icon and a thumbnail icon based on at least one of the size selection and the represented file. The method additionally includes generating the selected icon having the selected size and icon type.

In yet an additional aspect of the invention, a system is provided for enhancing icon display. The system includes a user icon scaling module for allowing a user to select an icon size for an icon representing an underlying file. The system additionally includes a resource selection module for selecting an image resource for generating the icon based on the size selection.

In yet a further aspect of the invention, a system is provided for enhancing icon display. The system includes a user icon scaling module for allowing a user to select an icon size for an icon representing an underlying file. The system additionally includes a type selection module for selecting a type of icon including at least one of a traditional icon and a thumbnail icon, the type selection based on at least one of the size selection and the underlying file.

### BRIEF DESCRIPTION OF THE DRAWINGS

The present invention is described in detail below with reference to the attached drawings figures, wherein:

FIG. 1 is a block diagram illustrating a computerized environment in which embodiments of the invention may be implemented;

FIG. 2 is a block diagram illustrating an icon scaling system in accordance with an embodiment of the invention;

FIGS. 3A-3G are samples or different types and sizes of icons in accordance with an embodiment of the invention;

FIG. 4 is a block diagram illustrating an icon configuration in accordance with an embodiment of the invention;

FIG. 5 illustrates several thumbnail icon configurations in accordance with an embodiment of the invention;

FIGS. 6A-6F illustrate multiple embodiments of visual effects for icons in accordance with an embodiment of the invention;

FIG. 7 illustrates a user scale for allowing a user to scale icons in accordance with an embodiment of the invention;

FIG. 8 is a flow chart illustrating a process for determining what type of icon to use in accordance with an embodiment of the invention; and

FIG. 9 is a flow chart illustrating a process for accessing image resources in accordance with an embodiment of the invention.

### DETAILED DESCRIPTION OF THE INVENTION

I. System Overview

Embodiments of the invention include a method and system for enabling scaling of icons to enhance a user experience. Icon scaling enables users to resize the icons in file management systems, such as Microsoft Windows Explorer, to any size in a range from a small size appropriate for looking at a long list of items to a very large size appropriate for looking at a small number of thumbnails within a single view. As an icon is resized, the appearance and layout of the icon change to best accommodate its new size.

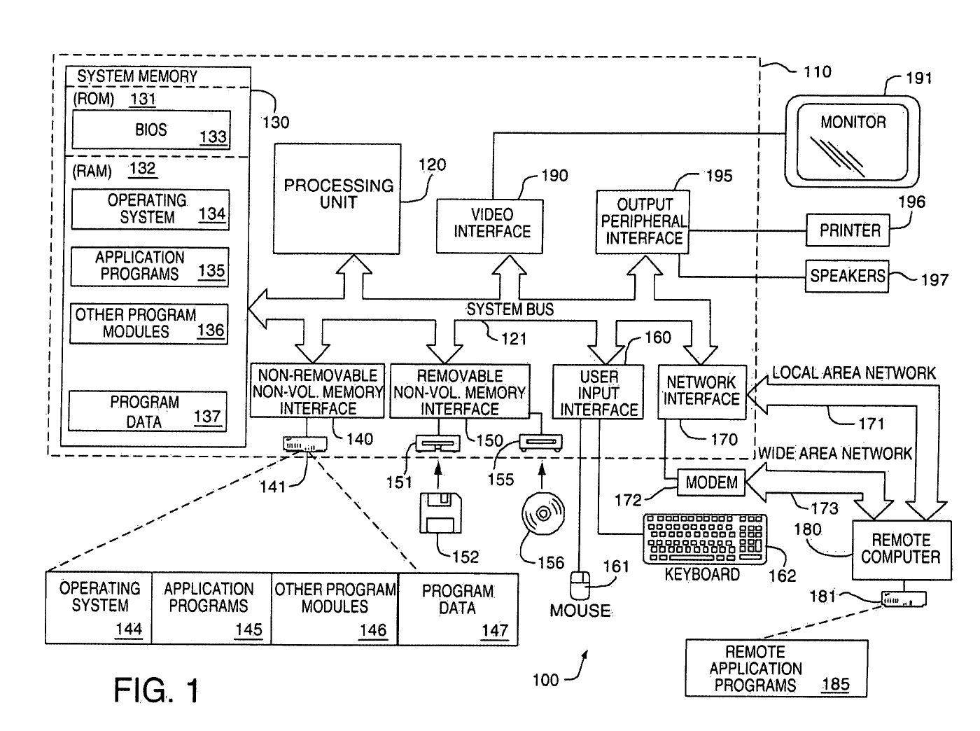

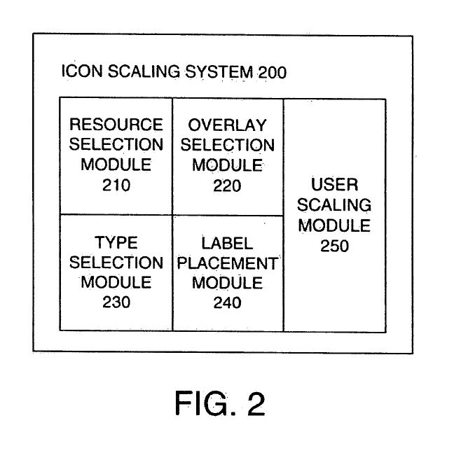

FIG. 2 illustrates an icon scaling module 200 in accordance with an embodiment of the invention. The icon scaling module 200 may be implemented as one or more program modules in a computerized environment as described below with reference to FIG. 1. The icon scaling module 200 may include a resource selection module 210, an overlay selection module 220, a type selection module 230, a label placement module 240, and a user scaling module 250. Through the user scaling module 250 a user is able to select an icon size. Based on the user scaling selection, the type selection module 230 selects a type of icon such as a thumbnail or traditional icon. Also based on the user scaling selection, the resource selection module 210 selects a particular image resource for scaling, the overlay selection module 220 selects, scales, and positions a status overlay and/or a type overlay, and the label placement module 240 determines an appropriate location for a label associated with the icon.

Icons are authored using a predetermined set of sizes, such as 16×16 pixels and 32×32 pixels. When a user chooses to view an icon at a size that is not one of the predetermined sizes, the scaling module 200 interpolates to determine what image to show the user. When the size of an icon is changed, variable including the type of icon, the image resource, label placement, and overlay configuration may be impacted as set forth above.

II. Exemplary Operating Environment

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is described in the general context of computer-executable instructions, such as program modules, being executed by a computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

With reference to FIG. 1, the exemplary system 100 for implementing the invention includes a general purpose-computing device in the form of a computer 110 including a processing unit 120, a system memory 130, and a system bus 121 that couples various system components including the system memory to the processing unit 120.

Computer 110 typically includes a variety of computer readable media. By way of example, and not limitation, computer readable media may comprise computer storage media and communication media. The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/nonremovable, volatile/nonvolatile computer storage media. By way of example only, FIG. 1 illustrates a hard disk drive 141 that reads from or writes to nonremovable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 in the present invention will operate in a networked environment using logical connections to one or more remote computers, such as a remote computer 180. The remote computer 180 may be a personal computer, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Although many other internal components of the computer 110 are not shown, those of ordinary skill in the art will appreciate that such components and the interconnection are well known. Accordingly, additional details concerning the internal construction of the computer 110 need not be disclosed in connection with the present invention.

III. Sample Icons

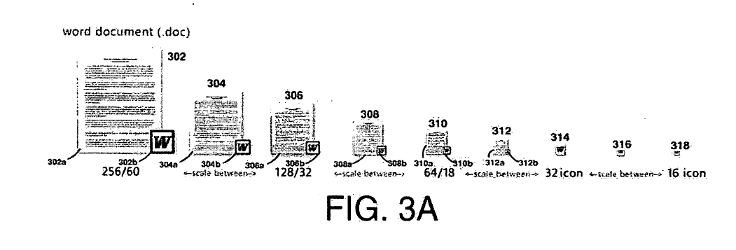

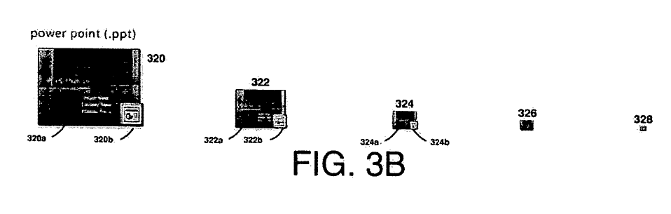

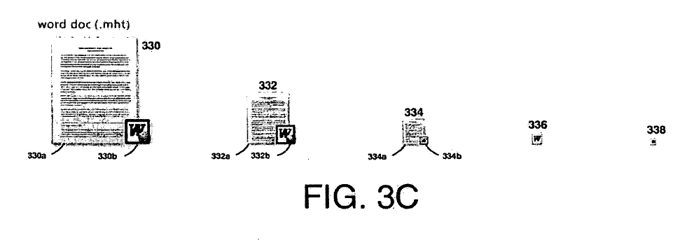

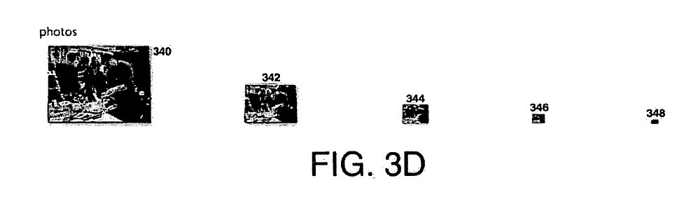

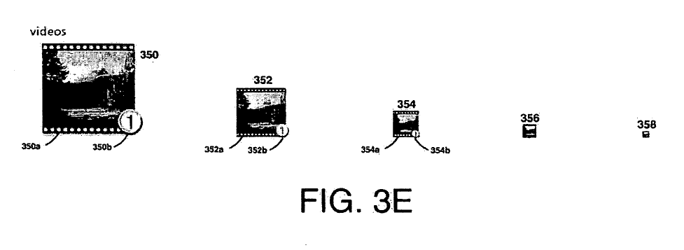

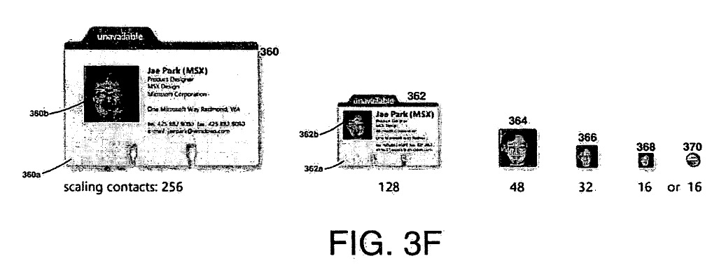

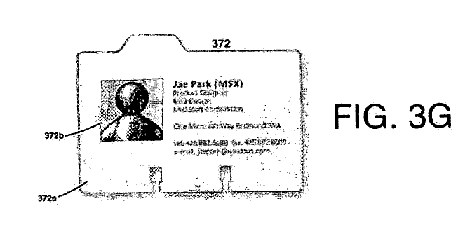

FIG. 3A-3G illustrate a sampling of icons in various sizes. FIG. 3A illustrates a sampling of document icons 302, 304, 306, 308, 310, 312, 314, 316, and 318. The document icons 302, 304, 306, 308, 310, and 312 each include respective document images 302a, 304a, 306a, 308a, 310a, and 312a. Each of the aforementioned document icons additionally includes a type overlay 302b, 304b, 306b, 308b, 310b, and 312b. These type overlays indicate a type of underlying document. The document icon 302 is shown has having a 256×256 pixel overall icon size and a 60×60 pixel type overlay portion. The images and overlays are scaled independently of one another, such that the image 304a is scaled between the images 302a and 306a and the overlay 304b is scaled between the overlays 302b and 306b. Document icon 306 is the next available document size. The overall size of icon 306 is 128×128 pixels and the overlay portion is 32×32 pixels. Document icon 304 is an icon scaled between the standard sized icons 302 and 306. Similarly, document icon 308 is scaled between the document icon 306 and the document icon 310, which includes a 64×64 overall icon size and an 18×18 pixel overlay portion 310b. Document icon 314 is a 32×32 pixel icon that includes only an overlay portion because its size is too small to clearly display both an overlay and a document image. Document icon 312, which is scaled between document icon 310 and 314 show both the document image portion 312a and the type overlay portion 312b. Smaller icons 316 and 318 both show only the type overlay portion of the item. The respective type overlays indicate the type of document such as a Microsoft Word document. In embodiments of the invention, the document icons are provided in six sizes including 16×16, 24×24, 32×32, 48×48, 128×128, and 256×256 pixels. In alternate embodiments, some of these sizes may be omitted and/or additional sizes may be included.

FIG. 3B illustrates a set of Microsoft Power Point Icons 320, 322, 324, 326, and 328. The Icons 320, 322, and 324 include an image portion 320a, 322a, and 324a. The icons 320, 322, and 324 also include overlay portions 320b, 322b, and 324b. The icons 326 and 328 are too small to be displayed with both portions. Accordingly these icons include only a thumbnail image. The decision to show a thumbnail image or an overlay may be made on a per type basis.

FIG. 3C also includes a set of icons 330, 332, 334, 336, and 338. The icons 330, 332, and 334 include respective image portions 330a, 332a, and 334a and overlay portions 330b, 332b, and 334b indicating that the document is an .mht document. Icons 336 and 338 are too small to adequately display both portions and therefore include only the type overlay portion to indicate the type of underlying document.

FIG. 3D illustrates a plurality of scaled photo icons 340, 342, 344, 346, and 348. These icons are preferably thumbnail icons that include a photograph from within the underlying file. They thumbnail icons shown display useful information and include no overlay portion.

FIG. 3E illustrates a set of video icons 350, 352, 354, 356, and 358. The icons 350, 352, and 354 each include a respective image portion 350a, 352a, and 354a. The included images may be thumbnail images. The icons 350, 352, and 354 each also include a respective type overlay portion 350b, 352b, and 354b. The icons 356 and 358 include only the image portion, which may be a thumbnail image, as the icons are too small to include both portions.

FIG. 3F illustrates a set of contact icons 360, 362, 364, 366, 368, and 370. The icons 360 and 362 each include a respective image portion 360b and 362b, which may be a thumbnail image, and a respective informational portion 360a and 362a. Icons 364, 366, and 368 include only image portion, as the icons are too small to show both the image and informational portion. Icon 370 illustrates a generic image that may be shown if a thumbnail image is unavailable.

FIG. 3G illustrates a generic contact icon 372 that may be used when no photograph is available for the contact. The icon 372 includes a generic image 372b and an informational portion 372a.

IV. Overlays

As set forth above, the different icon sizes also include different overlay sizes. As set forth above with respect to FIG. 2, the selection and placement of overlays is based on user-selected scaling. The overlay selection module 220 determines an overlay configuration based on user scaling input.

Two kinds of overlays include status overlays and type overlays. The overlays shown above with respect to FIGS. 3A-G are type overlays that indicate a type. The type overlay is used for thumbnail icons to convey what type of object the thumbnail image portrays. The type overlays appear in a lower right-hand corner of the image. Status overlays serve as a visual cue to help a user quickly identify some piece of relevant information about an item being viewed. Status overlays may appear in a lower left hand corner of an image. A recommended use of a status overlay includes alerting the user of a transitional or temporary state of a file upon which a user may wish to act. An example would be putting a “new” overlay on a file that has just recently been created. Another possible use for a status overlay is indicating relevant context sensitive information upon which a user may wish to act. An example would be putting an “error” overlay on a file in the download manager that could not complete downloading. In general, information that is being conveyed through a status overlay should also be a property that can be used for sorting, grouping, stacking, filtering, and searching.

Table 1 describes what size overlay may be displayed on icons of different sizes in accordance with an embodiment of the invention.

TABLE 1

| | Corresponding |
|---|---|
| Icon Size | Overlay Size |
| 256 × 256 | 48 × 48 |
| 128 × 128 | 32 × 32 |
| 48 × 48 | 24 × 24 |
| 32 × 32 | 16 × 16 |
| 16 × 16 | 8 × 8 |

In embodiments of the invention, the overlays scale independently from the icons. Between each defined icon snap size such as 256×256, 128×128, 64×64, 32×32, and 16×16, the overlays may scale linearly between the two overlay sizes. Table 2 shows one embodiment of the overlay sizes relative to icon sizes along a continuous range.

[image]

V. Icon Types and Layouts

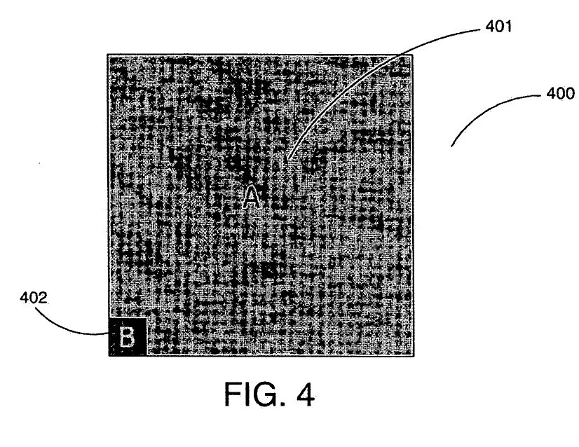

FIG. 4 illustrates a traditional icon 400 including an icon image 401 and a status overlay 402. The icon image 401 may be stored as a bitmap or may be dynamically generated. The status overlay 402 is used to convey status information about an item. The status overlay may also be dynamically generated or may be stored as a bitmap. In the displayed embodiment, the icon image 401 has dimensions of width=height=X. In embodiments of the invention, the status overlay 402 is drawn at the bottom left corner of the image so that the bottom edge of the overlay 402 is aligned with the bottom edge of the icon 400 and the left edge of the overlay 402 is aligned with the left edge of the icon 400. In alternative embodiments, the layout may be configured differently.

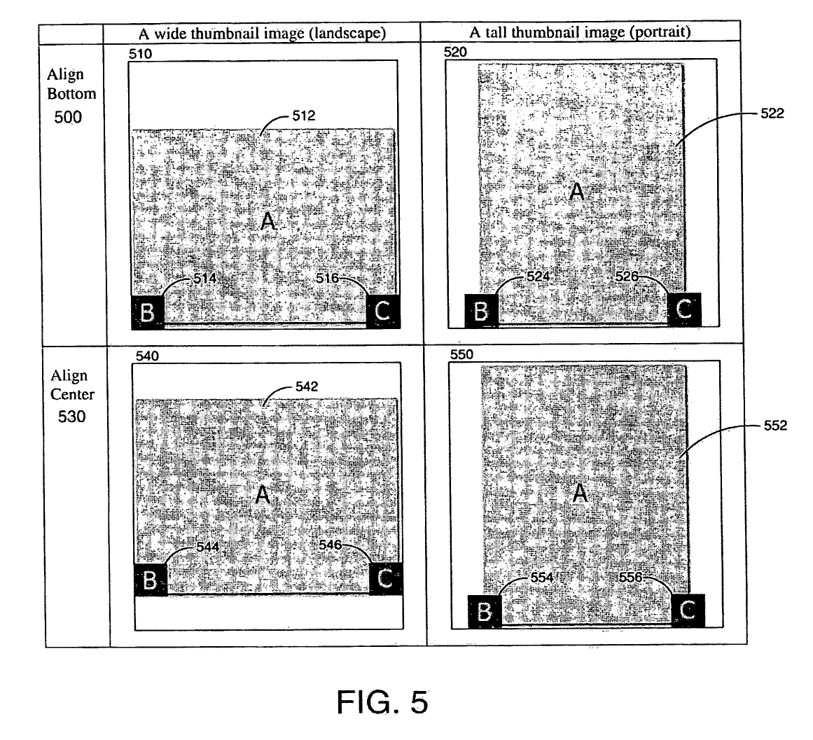

FIG. 5 illustrates layouts for a thumbnail icon in accordance with an embodiment of the invention. A row 500 illustrates bottom aligned thumbnail icons 510 and 520. A row 530 illustrates centrally aligned thumbnail icons 540 and 550. The bottom-aligned thumbnail icon 510 includes an image portion 512, a status overlay 514, and a type overlay 516. The bottom-aligned thumbnail icon 520 includes an image portion 522, status overlay 524, and a type overlay 526. The thumbnail icon 540 includes an image portion 542, a status overlay 544, and a type overlay 546. The thumbnail icon 550 includes an image portion 552, a status overlay 554, and a type overlay 556. In general, the image within each icon is denoted by (A), the status overlay by (B), and the type overlay by (C). The thumbnail icon itself is a square with a width and height equal to X. The thumbnail image (A) is scaled so that its longest dimension is at most equal to X.

As illustrated in FIG. 5, in all of the displayed configurations, the thumbnail image (A) is drawn horizontally centered within the thumbnail icon. The vertical placement of the thumbnail image (A) is determined by the type of view. If a current view has text labels placed below the icon then the bottom edge of the thumbnail image (A) should lie along the bottom edge of the thumbnail icon. If the current view has text labels placed to the side of the icon, then the thumbnail image (A) should be vertically centered within the thumbnail icon.

The placement of the status overlay (B) depends on the placement of the thumbnail image (A) within the thumbnail icon. The status overlay (B) fits within the boundaries of the thumbnail icon. Horizontally, the status overlay (B) may be centered around the left edge of the thumbnail image (A), but may be moved to the right when necessary, to avoid extending over a left boundary of the thumbnail icon itself.

The placement of the type overlay (C) depends on the placement of the thumbnail image (A) within the thumbnail icon. Vertically, like the status overlay (B), the bottom edge of the type overlay (C) lies along the bottom edge of the thumbnail image such that the type overlay (C) fits within the boundaries of the thumbnail icon when the thumbnail image (A) is bottom-aligned. Horizontally, like a mirror of the status overlay (B), the type overlay (C) should be centered around the right edge of the thumbnail image (A), but may be moved to the left when necessary, to avoid extending over the right boundary of the thumbnail icon itself.

In embodiments of the invention, for icons between 16×16 and 47×47 pixels, the label placement module 240 will position the filename beside the icon. For sizes 32×32 to 47, the label placement module 240 may provide additional tile information beside the icon. For sizes 48×48 and larger, the label placement module 240 places the filename below the icon.

In accordance with an embodiment of the invention, in a default mode, type overlays will be shown on a thumbnail icon if and only if it is within the document library. In this embodiment, type overlays will not be shown on photographs or video by default. A setting in the view options may be available to enable users to turn on or off the type overlays on documents. A mechanism such as an application program interface (API) may be provided that allows applications to associate a type overlay with each file type they own.

VI. Visual Enhancements

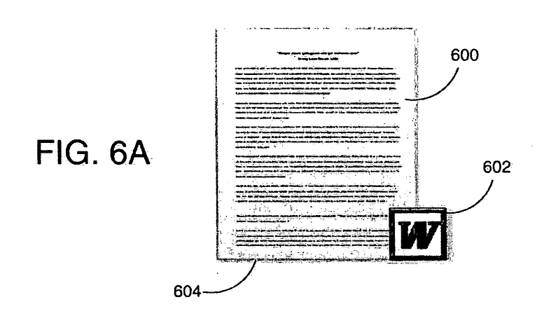

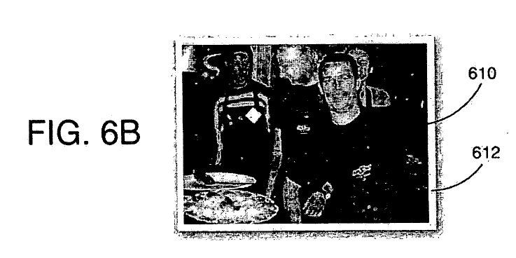

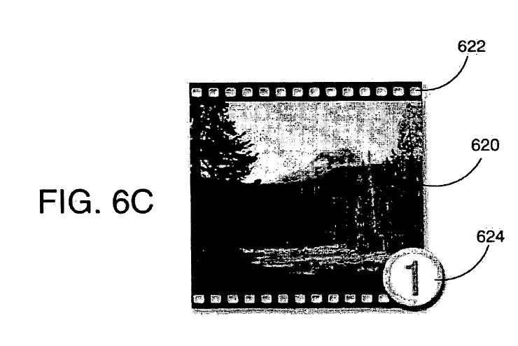

FIGS. 6A-6C illustrate visual enhancements applied to thumbnail icons in accordance with embodiments of the invention. There are several types of visual treatments that can be applied to thumbnail images and some of these treatments may further scale down an image.

FIG. 6A illustrates a thumbnail image 600 and a type overlay 602. A border 604 is applied and the icon may be registered to receive such a treatment. For example, Microsoft Word documents may be registered to have this treatment applied to them. The border is applied solely to the thumbnail image 600 and not to the entire bounding box of the thumbnail icon.

FIG. 6B illustrates a thumbnail image 610 having a photo paper border 612. The photo paper border 612 may be applied to a thumbnail if the underlying file is an “image” type and the icon size meets requirements. In embodiments of the invention, a photo paper border is applied to the thumbnail image if the thumbnail image is an image type and it is size 256, 128, 48 or 32. In this embodiment, no photo paper border is applied at size 16.

Table 3 describes the photo paper border width at each thumbnail icon size.

TABLE 3

| | Photo Paper |
|---|---|
| Icon Size | Border Width |
| 256 | 5 |
| 128 | 3 |
| 48 | 2 |
| 32 | 1 |
| 16 | No photo |
| | paper border. |

The width may be interpolated between the displayed sizes in a similar manner to the overlays shown in Table 2.

FIG. 6C illustrates a thumbnail image 620 having sprockets 622 and a type overlay 624. The sprockets may be applied to the thumbnail image 620 to convey that it is a movie type. The sprockets include two images placed along the top and bottom of the thumbnail image 620 to make it look like a piece of film strip. In embodiments of the invention, a pair of sprockets is applied to the thumbnail image if it is a perceived video type, and if the thumbnail icon size is 256, 128, 48, or 32. In this embodiment, no sprockets are applied at size 16. Table 4 describes the sprocket size at each thumbnail icon size in accordance with an embodiment of the invention.

TABLE 4

| Icon Size | Sprocket Height |
|---|---|
| 256 | 18 |
| 128 | 10 |
| 48 | 6 |
| 32 | 4 |
| 16 | No sprockets. |

The top sprocket may be placed so that its bottom edge aligns with the top edge of the thumbnail image, and the bottom sprocket may be placed so that its top edge aligns with the bottom edge of the thumbnail image. If the thumbnail image has a height large enough to make the thumbnail image with the sprockets higher than X pixels, then the two sprockets should be moved closer to one another. The top sprocket may be moved down and the bottom sprocket may be moved up until the thumbnail image with the applied sprockets is no taller than the height X.

Other effects may include a gradient effect that may be applied to thumbnail image to make it more attractive. Furthermore, a shine effect may be applied to the thumbnail image if the object type has been registered to receive such a treatment. For example, PowerPoint types may be registered to have this treatment applied to them. A thumbnail icon may also include a drop shadow effect or other visual effect.

VII. Using the Scaling Mechanism

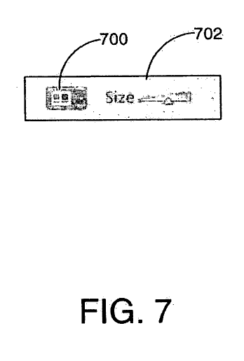

As set forth above, and as illustrated in FIG. 2, a user scaling module 250 receives user input for scaling. FIG. 7 illustrates a user scale for allowing a user to scale icons in accordance with an embodiment of the invention. Users can scale icons to sizes between 16×16 and 256×256. An icon size slider 702 is preferably provided in a view pane. A view mode control 700 allows a user to switch between an icon mode and a details mode. A user can move the icon slider 702 to adjust the icon size. The icon size slider 702 may have snap points around sizes 16, 32, 48, 128, and 256. If the slide control indicates a size within a few pixels of one of the snap sizes, the icons will snap to that size. In an embodiment of the invention, if the slider control is within four pixels in either direction of a snap size, the selected icons will be set at the snap size.

Additionally, a view menu may have an item labeled “Icon Size,” with the following choices appearing off a submenu: Tiny, Small, Medium, Large, and Huge, or similar selections that correspond to icon sizes such as 16, 32, 48, 128, and 256.

Finally, users may be able to scale icons using a scroll wheel found on many mice. Moving the scroll wheel forward while holding down the CTRL key can increase the size of the icon and moving the scroller wheel backward while holding down the CTRL key can decrease the size of the icon.

In absence of user scaling, the icons may have default sizes. The following Table 5 describes the default sizes of icons in various folder locations.

TABLE 5

| Place | Default Icons Size | Default Details Size |
|---|---|---|
| Document Library | 48 | 16 |
| Photo/Video | 128 | 16 |
| Library | | |
| Music/Radio | 48 | 16 |
| Library | | |
| Contact Library | 48 | 48 |

If the user selection requires that the icon be scaled between snap sizes, the system utilizes a scaling mechanism including a mechanism for converting the icons to an appropriate format, such as DX9 textures. A hardware accelerated scaling mechanism may implement a bilinear filter or other known mechanism to perform the actual icon scaling while maintaining visual fidelity of the image. The scaling occurs in real-time by the icon scaling system 200. The real-time scaling can occur at draw time or optionally at other times.

VIII. Type Selection Process

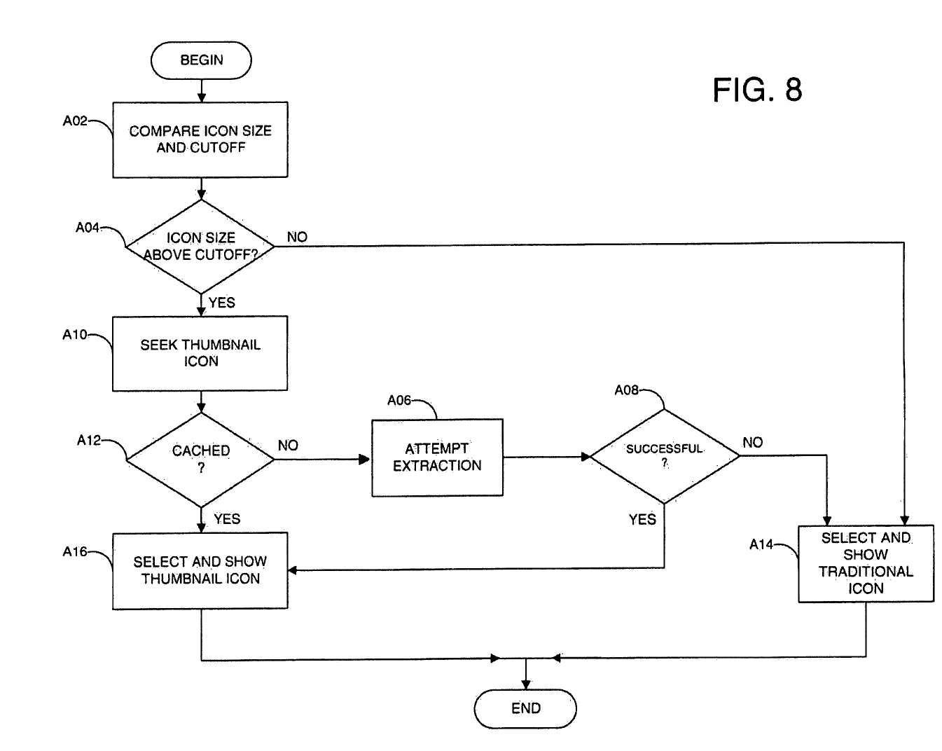

FIG. 8 is a flow chart illustrating a process implemented by the type selection module 230, shown in FIG. 2, for determining which type of icon should be used after a user has selected a particular icon size as explained above with respect to FIG. 7. As set forth above with regard to FIG. 2 the selection of a thumbnail icon or traditional icon typically depends upon the scaling selection of the user.

In step A02, the system compares the icon size and a pre-set size cutoff. If the icon size is above the pre-set size cutoff in step A04, the system seeks a thumbnail icon in step A10. If the icon is not above the size cutoff in step A04, the system selects and shows a traditional item in step A14.

In step A10, the system seeks a thumbnail icon. If a thumbnail icon is not cached in step A12, the system attempts to extract it in step A06. If the thumbnail is not cached in step A12, or if the extraction is successful in step A08, the system selects and shows the thumbnail icon in step A16. If the extraction is unsuccessful in step A08, the system selects and shows the traditional icon in step A14.

Exemplary icon size cutoffs are illustrated in Table 6 below.

TABLE 6

| Perceived Item Type | Thumbnail/Icon Cutoff |
|---|---|
| Document | 32 |
| Folder | 32 |
| Picture | Always thumbnail |
| Video | Always thumbnail |
| Stack (Phodeo) | Always thumbnail |
| Song | Always thumbnail |
| Stack (Album) | Always thumbnail |
| Stack (Artist) | Always thumbnail |
| People | Always thumbnail |
| Groups | Always thumbnail |
| Devices | Always thumbnail |
| Internet Shortcuts | 16 |

IX. Resource Selection and Scaling Process

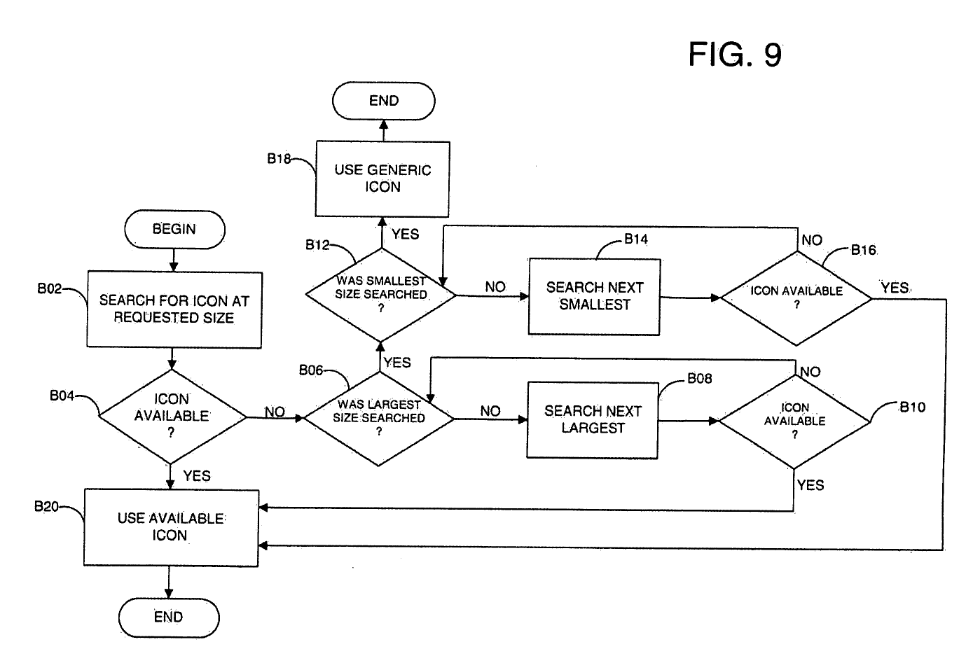

FIG. 9 illustrates a process for selection of an image resource by the resource selection module 210, illustrated in FIG. 2, after a user has scaled a selected icon.

As set forth above, the system provides image snap sizes. The sizes might include for example 16, 32, 48, 128, and 256. For every item Y at any size X the system may choose the image at the best available size for Y. In step B02, the system searches for the appropriate sized image X. If X is a snap size and an image for Y is available at size X in step B04, then the system uses the available image at size X in step B20. If an image for Y is not available in size X, in step B04, then the system determines if the largest size was searched in step B06. If the largest size was not searched in step B06, the system searches the next largest size in step B08. If the next largest image is available in step B10, the system uses the available icon in step B20. If the image is not available in step B10, the system continues the search until the largest image has been searched.

Subsequently, in step B12, if the search for larger images representing Y was unsuccessful, the system determines if the smallest size has been searched. If the smallest size has not been searched, the system continues to search for the next smallest size in step B14. If the image is available in step B16, the system uses it in step B20. If the icon is not available and the smallest size has been searched in step B12, the system uses a generic image in step B18. If and only if no image can be found at any size, the system will show a generic image. Although the process above is described as considering larger images prior to smaller images, the reverse process is also encompassed.

If the user selection requires that the image be scaled between snap sizes, the system utilizes a scaling mechanism including a mechanism for converting the images to an appropriate format, such as DX9 textures. A hardware accelerated scaling mechanism implements a bilinear filter to perform the actual image scaling. In addition to scaling the retrieved image, the system also attempts to re-extract at the correct size. The system uses the closest stored image it can find in the interim time. Once the system re-extracts, it displays the correctly sized image and also stores the new correctly sized image into a cache for subsequent retrieval. This extraction, display, store-into-cache sequence also occurs if the cache is empty and first displays the traditional icon.

### X. CONCLUSION

Thus, icon scaling in accordance with the invention enables users to resize icons to any size in a range from a small size to a very large size, depending upon user preference. As an icon is resized, the appearance of the icon and the layout of the icons changes to best accommodate its new size.

Users can, in real-time, scale icons across the continuous range of possible sizes, and the scaling is visually appealing. Thumbnail icons consistently convey what type of object they represent (e.g. Word Document, PowerPoint deck, video clip, etc.) even for thumbnail extractors written by ISVs. Overlays are used in a consistent and reliable way as visual cues conveying some information about an item.

While particular embodiments of the invention have been illustrated and described in detail herein, it should be understood that various changes and modifications might be made to the invention without departing from the scope and intent of the invention. The embodiments described herein are intended in all respects to be illustrative rather than restrictive. Alternate embodiments will become apparent to those skilled in the art to which the present invention pertains without departing from its scope.

From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the appended claims.

1. A method for displaying an icon representing an underlying file on a user interface, the method comprising:
providing a user with a size selection mechanism for selecting an icon size from a range of sizes;
searching a set of stored resources related to the underlying file; and
generating the icon in the selected size based upon the stored resources.

2. The method of claim 1, further comprising providing the user with a selection of a continuous range of sizes.

3. The method of claim 2, further comprising searching a set of stored image resources that includes a set of images having a number of discrete sizes.

4. The method of claim 2, further comprising interpolating between discrete sizes to generate an icon between discrete sizes.

5. The method of claim 1, further comprising placing a label in a vicinity of the generated icon based upon the selected size.

6. The method of claim 1, further comprising selecting and positioning an overlay in the vicinity of the generated icon based upon the selected size.

7. The method of claim 1, further comprising generating one of a traditional icon and a thumbnail icon based upon at least one of the selected size and the underlying file.

8. The method of claim 7, further comprising generating the thumbnail icon if the selected size is above a predetermined threshold and generating the traditional icon if the selected size is not above the predetermined threshold.

9. The method of claim 6, further comprising positioning a type overlay in a bottom right corner of the generated icon.

10. The method of claim 6, further comprising positioning a status overlay in a bottom left corner of the generated icon.

11. The method of claim 6, further comprising scaling the selected overlay based upon the selected icon size.

12. A computer readable medium storing computer executable instructions for performing the method of claim 1.

13. A method for enhancing display of icons on a user interface, the method comprising:
providing a user selection component for allowing a user to select an icon size for an icon representing a file;
selecting an icon type including one of a traditional icon and thumbnail icon based on at least one of the user's size selection and the represented file; and
generating the selected icon having the selected size and icon type.

14. The method of claim 13, further comprising providing the user with a selection of a continuous range of sizes.

15. The method of claim 13, further comprising searching a set of stored image resources upon receiving the user size selection, the stored set of image resources including a set of images having a number of discrete sizes.

16. The method of claim 15, further comprising interpolating between discrete sizes to generate an icon between discrete sizes.

17. The method of claim 13, further comprising placing a label in a vicinity of the icon based upon the selected size.

18. The method of claim 13, further comprising selecting and positioning an overlay in the vicinity of the selecting icon based upon the selected size.

19. The method of claim 18, further comprising positioning a type overlay in a bottom right corner of the generated icon.

20. The method of claim 18, further comprising positioning a status overlay in a bottom left corner of the generated icon.

21. The method of claim 18, further comprising scaling the overlay based upon the selected icon size.

22. The method of claim 13, further comprising generating the thumbnail icon if the selected size is above a predetermined threshold and generating the traditional icon if the selected size is not above the predetermined threshold.

23. A computer readable medium storing the computer executable instructions for performing the method of claim 13.

24. A system for enhancing icon display, the system comprising:
a user icon scaling module for allowing a user to select an icon size for an icon representing an underlying file; and
a resource selection module for selecting an image resource for generating the icon based on the size selection.

25. The system of claim 24, wherein the user icon scaling module comprises a selection of a continuous range of sizes.

26. The system of claim 24, wherein the resource selection module comprises a set of images having a number of discrete sizes.

27. The system of claim 24, further comprising a label placement module for placing a label in a vicinity of the icon based upon the selected size.

28. The system of claim 24, further comprising an overlay selection module for selecting, positioning, and sizing an overlay in the vicinity of the generated icon based upon the selected size.

29. The system of claim 24, further comprising a type selection module for selecting one of a traditional icon and a thumbnail icon based upon at least one of the selected size and the underlying file.

30. A system for enhancing icon display, the system comprising:
a user icon scaling module for allowing a user to select an icon size for an icon representing an underlying file; and
a type selection module for selecting a type of icon including at least one of a traditional icon and a thumbnail icon, the type selection based on at least one of the size selection and the underlying file.

31. The system of claim 30, wherein the user icon scaling module comprises a selection of a continuous range of sizes.

32. The system of claim 30, further comprising a resource selection module for providing multiple image sizes, the resource selection module accessing a set of images have a number of discrete sizes.

33. The system of claim 30, further comprising a label placement module for placing a label in a vicinity of the icon based upon the generated icon size.

34. The system of claim 30, further comprising an overlay selection module for selecting, positioning, and sizing an overlay in the vicinity of the generated icon based upon the selected size.
